(19) United States
(12) Patent Application Publication
(10) Pub. No.: US 2004/0115327 A1
(43) Pub. Date: Jun. 17, 2004

(54) High protein and low calorie raw batter for making products resembling potato-based products, and method for preparing same

(76) Inventor: Reginald Allouche, Paris (FR)

Correspondence Address: MCCRACKEN AND FRANK, 200 W. ADAMS STREET, SUITE 2150, CHICAGO, IL, 60606, US

(21) Appl. No.: 10/296,276

(22) PCT Filed: Jan. 16, 2001
(86) PCT No.: PCT/FR01/00129

(30) Foreign Application Priority Data
May 24, 2000 (FR) FR00/01409

(51) Int. Cl. A21D 10/00

(52) U.S. Cl. 426/549

(57) ABSTRACT

The invention concerns a high protein and low calorie food preparation in the form of a raw batter capable of being shaped, in particular into sticks, balls, patties or portions, designed to be cooked directly at the time of consumption and enabling to obtain products copying or resembling traditional potato-based products. The invention also concerns the method for preparing the food batter and food preparations obtained by said method.

The subject of the present invention is a food preparation in the form of a raw batter capable of being shaped in particular into sticks, balls, patties or portions, generally refridgerated or deep-frozen, which is designed to be directly cooked at the time of consumption so as to give products copying or resembling traditional potato-based products such as, for example, fries, dauphine potatoes, deep-fried potato balls, “rosti” potatoes or potato pancakes, said food preparation having a high protein content and a low carbohydrate and lipid content.

The invention also relates to a food preparation in the form of sticks, balls, patties or portions, which have undergone no cooking or precooking treatment, designed for the preparation, by cooking, of products copying or resembling traditional potato-based products, which is obtained by shaping the food preparation in the form of a raw batter.

The abovementioned traditional potato-based products are par excellence products reputed anti-diet because, even if they do not necessarily initially contain a high lipid content, their preparation necessarily requires precooking or cooking in a, or with the aid of a vegetable or animal fat. That is obviously the case for fries cooked in a bath of vegetable oil or fat, or potato pancakes which, while they can simply be reheated in a nonstick frypan, have undergone a precooking step in the presence of fat during their preparation.

While it is obvious that consumers are increasingly aware of their physical appearance and do not therefore wish to gain weight, it is also true that they nevertheless wish to continue eating while having fun, that is to say eating tasty products to satiety. They are therefore increasingly led to turn to multiple so-called “slimming” diets which are most generally characterized by a lower daily calorie supply, obtained by a lower quantity of ingested food which is most often associated with a reduction in the lipid content. Unfortunately, these diets are difficult to observe over a long period and cause weight loss linked to a loss of muscle mass (i.e. lean mass). A lack of skin tone and elasticity, and a physical and intellectual asthenia are then observed. In addition, people following these diets by the letter do not eat as much as they would wish and therefore suffer from hunger and feel frustrated.

A need therefore exists to have diet products which, while being low in calories, do not cause the harmful consequences indicated above and which allow the consumer to follow a diet with pleasure, that is to say which allow him to eat to satiety and to lose his fatty mass, without this being at the detriment of his lean mass.

It is recognized that it is necessary to supply the body, during these periods of calorie reductions, a minimum and sufficient supply of proteins of high nutritional and biological value.

However, this additional constraint further complicates the exercise of formulating food compositions which are at once low in calories, industrializable, organoleptically satisfactory, stable from the point of view of aging and which are easy to prepare, without the addition of fat.

However, it is to the merit of the applicant to have succeeded in developing, after numerous trials, a food preparation which, once prepared by the consumer, resembles or copies traditional potato-based products, and which is at once high in protein, low in calories, organoleptically satisfactory, stable from the point of view of texture, and easy to prepare.

Said food preparation is provided in the form of a generally refrigerated or deep-frozen raw batter designed to be directly cooked shortly before or at the time of consumption.

This batter may be shaped into sticks, balls, patties, for example before refrigeration or deep-freezing, or may be sold in the form of lumps designed to be shaped into pancakes or patties, for example, directly in the home of the consumer or the final user, shortly before cooking.

This batter is characterized in that it has, the percentages being expressed in weight per weight relative to the commercial product:

a protein content (measured in N×6.25) of between 14 and 30%, preferably between 18 and 28% and still more preferably between 20 and 26%,

a carbohydrate content of between 3 and 15%, preferably between 3 and 13%, and still more preferably between 3 and 12.5%,

a lipid content of between 0.5 and 5%, preferably between 0.5 and 4%, and still more preferably between 0.9 and 3.7%,

a water content of 40 to 70%.

The total calorie value of the commercial product is between 130 and 230 kcal/100 g, preferably between 130 and 190 kcal/100 g and still more preferably between 132 and 180 kcal/100 g.

The food batter according to the invention is also characterized in that its chemical index is greater than 100. It is recalled that the expression chemical index of a protein is understood to mean the product by 100 of the smallest of the quotients obtained by dividing, for each of the essential amino acids or groups of essential amino acids, the quantity present in 100 g of this protein by the corresponding quantity present in 100 g of the protein serving as reference, the latter being characterized by the following contents expressed relative to 100 g:

| | | |
|---|---|---|
| L isoleucine | 4 | g |
| L leucine | 7 | g |
| L lysine | 5.5 | g |
| DL methionine + L cystine | 3.5 | g |
| L phenylalanine + L tyrosine | 6 | g |
| L threonine | 4 | g |
| L tryptophan | 1 | g |
| L valine | 5 | g |

The proteins used for making the food batter in accordance with the invention may be of animal and/or plant origin.

The use of milk proteins, such as casein, caseinates, total milk protein, lactalbumin, whey; egg proteins; soybean, pea, lupine or yeast proteins in particular, is preferred.

As carbohydrates, it is possible to use any type of starch, of any origin, native or modified, in particular corn starch, potato starch, cassava starch, potato flakes; sugars and polyols.

As lipids, the use of powders of copra, palm, soybean or sunflower fat is preferred.

Of course, the batter in accordance with the invention may also contain other conventional ingredients such as flavorings, thickeners, amino acids, spices, condiments, taste enhancers, colorings, vitamins, minerals, soluble or insoluble fibers such as in particular inulin or glucose or fructose polymers, leavening powders and intense sweeteners; and may additionally contain vegetable, meat, fish, cheese or fruit pieces or powder.

According to a preferred embodiment, the batter according to the invention contains, as a percentage by weight relative to the commercial product:

from 10 to 30%, preferably from 14 to 28%, and still more preferably from 17 to 25% of milk proteins,

from 2 to 12%, preferably from 2.5 to 10%, and still more preferably from 3 to 10% of potato flakes,

a binder such as whole egg powder or egg white, in a quantity generally between 2 and 10%, preferably between 2.5 and 9%, and still more preferably between 2.8 and 7%,

at least one thickener, preferably chosen from gums (guar, carob, carrageenan, alginate, xanthan, and the like) and starches, in particular pregelatinized or extruded starches, this thickener being most generally present in a quantity of between 0.5 and 3%, preferably between 0.8 and 2.5%, and still more preferably between 1 and 2.3%,

water, in a quantity of between 42 and 70%, preferably from 45 to 70%,

one or more flavorings, in a quantity generally between 0.2 and 4%, preferably between 0.3 and 3.5%, and still more preferably between 0.8 and 3.2%.

The subject of the invention is also the method for preparing the food batter according to the invention, this method comprising the following steps:

selecting the ingredients, weighing and measuring out, said ingredients being for the majority in powder form,

intimately mixing these ingredients, with or without premixing,

adding water to said mixture, with moderate and regular stirring, for example in a kneader, in order to lead to the formation of a bound and homogeneous batter,

shaping,

optionally treating by means of refrigeration or deep-freezing.

The shaping step may consist in particular in laminating followed by cutting or shaping into individualized portions such as fries, dauphine potatoes, minipatties and the like, or may simply consist in forming into lumps, the latter being directly formed in the home of the final user.

It is important to underline that the method according to the invention does not provide for a cooking or precooking step. The final product is therefore directly prepared in the home of the user, by cooking in an oven, in a frypan or by infrared cooking.

The invention will be understood more clearly with the aid of the following examples which are given purely by way of illustration.

### EXAMPLE 1

A raw food batter in accordance with the invention is prepared from the formulation presented in Table 1 below.

TABLE 1

| Ingredients | % by weight |
|---|---|
| Flavoring NN0833 (Company QUEST) | 0.62 |
| Sodium bicarbonate | 0.15 |
| Sodium caseinate 220 (Company EPI | 10.96 |
| INGRÉDIENT) | |
| Sweet lupine flour (CANA) | 1.55 |
| Fiber ID 60 (Company ARNAUD) | 1.55 |
| Isaguar gum (Company DISATEC) | 0.62 |
| L-methionine (Company QUIMDIS) | 0.06 |
| Egg powder (Company OVONOR) | 2.49 |
| Potato flakes | 7.57 |
| Fibers Profiber PTF (Company FPS) | 1.87 |
| Sodium pyrophosphate | 0.31 |
| Salt | 0.62 |
| Vana Grassa 80C093 (Company ARNAUD) | 0.93 |
| Soybean proteins 90HDS (Company LUCAS | 1.86 |
| MEYER) | |
| Water | 68.84 |
| Total protein content | 14.21 |
| Total carbohydrate content | 6.73 |
| Total lipid content | 2.27 |

The batter obtained by mixing the various ingredients and the chosen content of water has a fairly smooth texture, without lumps. It is homogeneous but gives, after kneading, a batter which is slightly too hard. In this formulation, the protein is predominantly composed of milk proteins, but soybean proteins are added because they make it possible to obtain a degree of retention of water. The lupine flour makes it possible to create a network in the batter, which is thereby homogeneous. The sodium bicarbonate level is sufficient. It was observed that increasing it, in excessively large proportions, caused excessive swelling during cooking of the food batter.

An organoleptic test performed by a taste panel on fries formed from the food batter and cooked in a traditional oven gives a vegetable taste which is slightly too pronounced. Moreover, during the preparation of the products formed, slight sticking was observed during the laminating step.

### EXAMPLE 2

Another formulation (see composition in Table 2 below) is therefore prepared with the objective of reducing sticking during the laminating step and in order to improve the taste.

Another flavoring is used (flavoring DF11664 from the company QUEST) in a higher content, and the content of potato flakes is increased from 7.57% to 8.15%.

In order to reduce the hardness of the batter, the fiber content (PROFIBER and fibers ID60) is slightly reduced and partially compensated by a slight increase in the content of Vana Grassa, which provides unctuousness. The protein content is also increased, by raising the level of soybean proteins and of sodium caseinate, which makes it possible to reduce sticking during lamination by virtue of the high water absorption capacity of these proteins.

TABLE 2

| Ingredients | % by weight |
|---|---|
| Flavoring DF11664 (Company QUEST) | 1.06 |
| Sodium bicarbonate | 0.17 |
| Sodium caseinate 220 (Company EPI | 14.53 |
| INGRÉDIENT) | |
| Sweet lupine flour (CANA) | 1.59 |
| Protein fiber ID 60 (Company ARNAUD) | 0.88 |
| Isaguar gum (Company DISATEC) | 0.81 |
| L-methionine (Company QUIMDIS) | 0.07 |
| Egg powder (Company OVONOR) | 2.48 |
| Potato flakes | 8.15 |
| Profiber PTF (Company FPS) | 1.06 |
| Sodium pyrophosphate | 0.28 |
| Salt | 0.63 |
| Vana Grassa 80C093 (Company ARNAUD) | 1.20 |
| Soybean proteins 90HDS (Company LUCAS | 2.48 |
| MEYER) | |
| Water | 64.61 |
| Total protein content | 17.87 |
| Total carbohydrate content | 7.47 |
| Total lipid content | 2.5 |

The batter obtained using this formulation is homogeneous but is found to be too crumbly and fragile, not sufficiently elastic and too brittle. A slightly crumbly character is noted, during the laminating step, on the edge of the laminated batter. Cooking the preformed food batter in the form of fries, carried out in a traditional oven, makes it possible to obtain homogeneous cooking.

The fries thus made are well liked by the taste panel, who nevertheless still observed a slightly too pronounced vegetable taste.

### EXAMPLE 3

A raw food batter in accordance with the invention is prepared from the ingredients listed in Table 3 below:

TABLE 3

| Ingredients | % by weight |
|---|---|
| Flavoring DF11664 (Company QUEST) | 2.73 |
| Sodium bicarbonate | 0.09 |
| Sodium caseinate 220 (Company EPI | 22.50 |
| INGRÉDIENT) | |
| Potato flour PJ30 | 0.45 |
| Inulin RAFTILINE GR (Company ARNAUD) | 2.27 |
| Isaguar gum (Company DISATEC) | 0.91 |
| L methionine (Company QUIMDIS) | 0.11 |
| Egg powder (Company OVONOR) | 3.18 |
| Potato flakes | 9.32 |
| Salt | 1.23 |
| Vana Grassa 80C093 (Company ARNAUD) | 1.30 |
| Soybean proteins 90HDS (Company LUCAS | 1.36 |
| MEYER) | |
| Water | 54.55 |
| Total protein content | 23.32 |
| Total carbohydrate content | 9.9 |
| Total lipid content | 2.7 |

An extremely homogeneous batter having good textural properties is obtained from this formulation. The smoothness and the elasticity of the batter were improved by adding inulin. The formulation has the advantage of a very high protein content. The kneading capacity is good but could be further improved by a slight increase in thickeners (Isaguar gum). The laminating operation is carried out very satisfactorily, the batter resisting well and stretching sufficiently. The cooking obtained in a traditional oven reveals a homogeneous cooking. The reduction in the fiber level (ID60 and Profiber PTF) makes it possible to reduce the crumbliness.

The tasting test carried out on fries prepared and cooked in a traditional oven gives extremely eulogistic results, the fries being judged by the tasters as having a good taste and a good odor and as having a taste and an appearance which are very similar to traditional potato fries.

The possibility therefore exists, by virtue of the invention, to make high protein and low calorie products not requiring for their cooking any addition of fat and having the textural and organoleptic characters of traditional potato based products. These products may be easily prepared, and may be sold in refrigerated or deep-frozen form, for very easy cooking directly by the consumer, for example in a traditional oven or in a frypan with an nonstick coating.

Of course, the various ingredients cited and their respective contents may be modified without nevertheless departing from the scope of the invention.

1. A food preparation in the form of raw batter capable of being shaped, in particular into sticks, balls, patties or portions designed to be directly cooked at the time of consumption and allowing the production of products copying or resembling traditional potato-based products, having a protein content of between 14 and 30%, a carbohydrate content of between 3 and 15%, a lipid content of between 0.5 and 5%, a water content of 40 to 70%, these percentages being expressed by weight per weight relative to the commercial product, and a chemical index greater than 100.

2. The food preparation in the form of raw batter as claimed in claim 1, having a binder content of between 2 and 10%, preferably between 2.5 and 9%, and still more preferably between 2.8 and 7%, these percentages being expressed by weight per weight relative to the commercial product.

3. The food preparation in the form of raw batter as claimed in either of claims 1 and 2, having a protein content of between 18 and 28%, preferably between 20 and 26%, a carbohydrate content of between 3 and 13%, preferably between 3 and 12.5%, and a lipid content of between 0.5 and 4%, preferably between 0.9 and 3.7%, these percentages being expressed by weight per weight relative to the commercial product.

4. The food preparation in the form of raw batter as claimed in any one of claims 1 to 3, characterized in that it has a total calorie value of between 130 and 230 Kcalories per 100 g, preferably between 130 and 190 Kcalories per 100 g, and still more preferably between 132 and 180 Kcalories per 100 g.

5. The food preparation in the form of raw batter as claimed in any one of claims 1 to 4, characterized in that it comprises from 10 to 30%, preferably from 14 to 28%, and still more preferably from 17 to 25% of milk proteins.

6. The food preparation in the form of raw batter as claimed in any one of claims 1 to 5, characterized in that it has a content of 2 to 12%, preferably of 2.5 to 10%, and still more preferably of 3 to 10% potato flakes.

7. The food preparation in the form of raw batter as claimed in any one of claims 2 to 6, characterized in that the binder consists of whole egg powder or egg white.

8. The food preparation in the form of raw batter as claimed in any one of claims 1 to 7, characterized in that it contains a thickener, preferably chosen from gums and starches, said thickener being present in a quantity of between 0.5 and 3%, preferably between 0.8 and 2.5%, and still more preferably between 1 and 2.3%.

9. The food preparation in the form of raw batter as claimed in any one of claims 1 to 8, having a water content of between 42 and 70%, preferably between 45 and 70%.

10. The food preparation in the form of raw batter as claimed in any one of claims 1 to 9, characterized in that it contains one or more flavorings, in a quantity of between 0.2 and 4%, preferably between 0.3 and 3.5%, and still more preferably between 0.8 and 3.2%.

11. A method for preparing the food batter in the form of raw batter as claimed in any one of claims 1 to 10, characterized in that it comprises the following steps:
selecting the ingredients, weighing and measuring them out,
intimately mixing these ingredients, with or without premixing,
adding water to said mixture, with moderate and regular stirring, for example in a kneader, in order to lead to the formation of a bound and homogeneous batter,
shaping,
optionally treating by means of refrigeration or deep-freezing.

12. The method as claimed in claim 11, characterized in that the shaping step consists in laminating followed by cutting or shaping into individualized portions such as fries, dauphine potatoes or minipatties.

13. A food preparation in the form of sticks, balls, patties or portions, which has undergone no cooking or precooking treatment, designed for the preparation, by cooking, of products copying or resembling traditional potato-based products, which is obtained by forming the rood preparation in the form of a raw batter as claimed in any one of claims 1 to 10.
